(19) United States
(12) Patent Application Publication
(10) Pub. No.: US 2010/0174390 A1
(43) Pub. Date: Jul. 8, 2010

(54) Solid-State Music Player And Host Docking System

(76) Inventors: Peter Garrett, Aptos, CA (US); Paul Regen, Felton, CA (US)

Correspondence Address: CENTRAL COAST PATENT AGENCY, INC, 3 HANGAR WAY SUITE D, WATSONVILLE, CA, 95076, US

(21) Appl. No.: 12/651,214

(22) Filed: Dec. 31, 2009

Related U.S. Application Data
(60) Provisional application No. 61/142,281, filed on Jan. 2, 2009.

(51) Int. Cl. G06F 17/30; G06F 17/00; G06F 12/00; G06F 13/20; G06F 3/041; G06F 3/048

(52) U.S. Cl. 700/94; 711/103; 710/303; 715/702; 707/626; 711/E12.001; 715/716

(57) ABSTRACT

A solid-state music player has a writable and erasable memory for storing music and a digital music player application, a speaker system for providing audio, a rechargeable battery for powering on the music player, and an interactive touch screen interface for controlling the functions and features of the music player. The solid-state music player may be removably docked into a docking bay provided in a communications device and then ejected for play in standalone mode.

### BACKGROUND OF THE INVENTION

1. Field of the Invention

The present invention is in the field of portable music devices and equipment and pertains particularly to methods and apparatus for integrating a hardware portable music player with a communications device for charging and loading the player with music for standalone play once ejected.

2. Discussion of the State of the Art

Mobile phone technology is becoming increasingly more advanced with the advent of smart phone technology. A smart phone is a communications device in the form of a mobile phone offering advanced communications and entertainment capabilities beyond what a typical mobile cellular telephone might offer. Many smart phones exhibit functionality similar to a personal computer (PC). Some smart phones are capable of running complete operating system software providing a standardized interface and platform for application developers.

A noticeable trend in the development of smart phone technology is the integration of software media players such as MP3 players, for example, which enable users to play their favorite MP3 music files stored on their smart phone or streamed from the Internet directly from their smart phone. While this technology integration has been beneficial to the user, it can be problematic to the user in certain scenarios. For example, some public places ban mobile telephones from being on at the premises. If a user, for example, was at a health club exercising where mobiles were not permitted to be turned on, he or she would be limited to the music playing on the global system for all users.

Other activities may not be compatible with the active use of an expensive mobile telephone to play music. For instance, some users may find that performing certain activities while using their mobile phone to listen to their music is cumbersome and carries an added threat of damaging their mobile phones. Some sports like mountain biking, surfing, snowboarding, and so on could be problematic relative to soundness of the mobile phone system used to play music while engaged in such activities.

Therefore, what is needed is a new type of hardware music player and host system that solves the problems stated above.

### SUMMARY OF THE INVENTION

The problem stated above is that portability is desirable for a digital audio system, but many of the conventional means for enabling portability for listening to music such as playing the music from a mobile telephone, also increase the risk of unpleasant circumstances occurring for a user attempting to listen to music. The inventors therefore considered functional components of a digital music system, looking for elements that exhibit interoperability that could potentially be harnessed to provide portable music but in a manner that would not create difficulties or missed opportunities to enjoy the music accessible from the player.

The present inventor realized in an inventive moment that if music could be stored on a communications device and then transferred to a portable music player that was dedicated to simply playing back the transferred selections, significant reduction in restrictive circumstances may occur. The inventor therefore constructed a unique music storing and rendering system for transferring and listening to music files that allowed dedicated portable use of the system for listening to music, but constrained the form factor of the music playing component to an economic and easily used profile compatible with most active situations where music might be played. A significant convenience for the user results, with no impediment to direct listening of stored music files created.

Accordingly, in an embodiment of the present invention, a solid-state music player is provided and includes a writable and erasable memory for storing music and a digital music player application, a speaker system for providing audio, a rechargeable battery for powering on the music player, and an interactive touch screen interface for controlling the functions and features of the music player. The music player may be removably docked into a docking bay provided in a communications device and then ejected for play in standalone mode.

In one embodiment, the solid-state music player has a form factor including a length, width, and thickness adapted for insert into a card slot provided in the communications device, the communications device functioning as a host device and docking station for the solid-state music player. In a variation of this embodiment, the communications device is a Smartphone. In a preferred embodiment the solid-state music player further includes a wireless transceiver and circuitry.

In one embodiment, the touch screen is an organic light emitting diode (OLED) touch screen. In one embodiment, the solid-state music player is also insertable into a pocket of a wearable arm or wrist band during standalone play when the player is not docked.

According to another aspect of the present invention, a music storing and rendering system is provided and includes a solid-state music player including a writable and erasable memory for storing music, a speaker system for providing audio, a rechargeable battery, and an interactive touch screen interface; and a communications device having a card slot with a form factor including a length, width, and thickness provisioned to accept the solid-state player in a removable state of docking.

In a preferred embodiment, the solid-state music player is accessible from a touch screen provided on the communications device. In a variation of this embodiment, the communications device is a Smartphone. In another variation of this embodiment, the touch screens are OLED touch screens.

In one embodiment, the card slot includes a mechanism for writing to and erasing from the memory of the solid-state music player while docked therein, the tasks controllable from one or more controls on the communications device. In one embodiment the system further includes a port for recharging a first rechargeable battery on the communications device and a second rechargeable battery on the solid-state music player.

In a preferred embodiment, music may be streamed wirelessly from the communications device to the solid-state music player while it is not docked to the communications device. In a variation of this embodiment, music may be streamed wirelessly from the solid-state music player to a hosted speaker unit or system while it is not docked to the communications device. In one embodiment, the solid-state music player and the communications device may be wirelessly synchronized to enable the same music selections stored for playback from either device.

According to another aspect of the invention, using a music storing and rendering system including a solid-state music player with a writable and erasable memory for storing music, a speaker system for providing audio, a rechargeable battery, and an interactive touch screen interface, and a communications device having a card slot with a form factor including a length, width, and thickness provisioned to accept the solid-state player in a removable state of docking, a method for establishing a portable music station including the steps (a) with the solid-state music player docked into the communications device, writing at least one music file to the memory on the player from another memory storing the at least one file, (b) ejecting the solid-state music player from the communications device, (c) staging the solid-state music player for listening to music, (d) selecting at least one of the stored music files, and (e) playing the at least one music file.

In one aspect of the method, in step (a), the music player charges while docked into the communications device. In a preferred aspect, in step (b), the solid-state music player is physically ejected by touching an icon on a touch screen on the communications device. In another aspect of the method, in step (c), the solid-state music player is inserted into a transparent pocket of an arm band or wrist band. In a preferred aspect of the method, in step (d), selection is made using a touch screen provided on the solid-state music player.

### BRIEF DESCRIPTION OF THE DRAWING FIGURES

FIG. 1 is an elevation view of a Smartphone with an ejectable solid-state music player according to an embodiment of the present invention.

FIG. 2 is a front view of the music player of FIG. 1 with the touch screen display removed for clarity.

FIG. 3 is a front view of the music player of FIG. 1 with the touch screen display illustrated.

FIG. 4 is a process flow chart illustrating steps for ejecting the player to listen to music.

### DETAILED DESCRIPTION

The inventors provide a unique music storing and rendering system for transferring and listening to music files that allowed dedicated portable use of the system for listening to music, but constrained the form factor of the music playing component to an economic and easily used profile compatible with most active situations where music might be played. The methods and apparatus of the invention are described in the following examples, which may include descriptions of more than one embodiment of the invention.

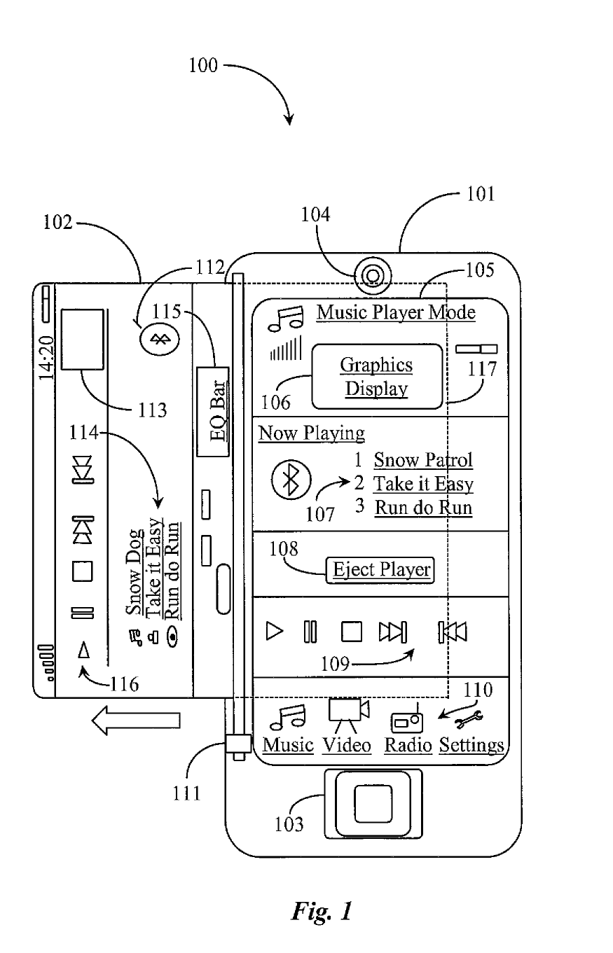

FIG. 1 is an elevation view of a Smartphone 101 with an ejectable solid-state music player 102 according to an embodiment of the present invention. A music playing system 100 includes Smartphone 101 and a solid-state music player 102. Smartphone 101 represents one type of communications device that may support hosting of a solid-state media player like player 102. Smartphone 101 includes many attributes common to a Smartphone. Smartphone 101 includes a digital camera 104 and a speaker system 103. Smartphone 101 may be adapted to play music stored in local memory or streamed from the Internet or from some external device memory. A software music player (not illustrated) is presumed installed on and operable from telephone 101. In this regard, Smartphone 101 can play music without using solid-state music player 102.

Smartphone 101 includes a docking bay 117 integrated within the body of the phone. Docking bay 117 is adapted to accept solid-state player 102. Docking bay 117 includes a charging mechanism for charging a battery provided on the solid-state music player and an eject mechanism for ejecting the solid-state player from the telephone. Music player 102 has a form factor similar to that of a credit card and may easily and conveniently fit inside the body of Smartphone 101 without interfering with any other electronics of the Smartphone.

Music player 102 is adapted as a standalone battery-powered player when not docked to Smartphone 101. Player 102 has a battery, speaker, and other circuitry required to enable full function as a music player. More detail about electronics components of solid-state player 102 is provided later in this specification. Player 102 has a touch screen 112, which may be an organic light emitting diode (OLED) touch screen. Touch screen 112 may extend partly over the surface of the player or it may take up the entire front surface of player 102.

Smartphone 101 has a touch screen 105, which may be an OLED touch screen. Touch screen 105 includes full touch screen navigation capability in several different modes. In this example, the Smartphone is set to music player mode. In music player mode, the touch screen typically includes controls and views for working with music, songs, playlists, etc. In music player mode, touch screen 105 includes a dynamic graphics display 106. Graphics display 106 may contain an album cover, video graphic, animated skin, or some other graphic representation of a song that is playing or a playlist that is being played.

Touch screen 105 on Smartphone 101 includes a now playing section that displays one or more song titles 107 of the songs that are loaded for play. Smartphone 101 is adapted for wireless transmission of music to another wireless enabled device. A Bluetooth™ icon is displayed in the now playing section of touch screen 105 indicating that the player is capable of streaming music to an external Bluetooth-enabled device.

An interactive eject option 108 is displayed in touch screen 105 of Smartphone 101 and may be selected and invoked to eject solid-state player 102. The ejection mechanism (not illustrated) may be a mechanical spring loaded system with a lock for preventing unintended ejection of the player from the phone. In this example a lock lever 111 must be positioned at the bottom of the host track to release a spring mechanism to facilitate physical ejection of the solid-state media player from the Smartphone.

Touch screen 105 on Smartphone 101 in player mode includes a control set 109 for play, pause, stop, skip forward, and skip backward. It is noted herein that many more controls may be added such as volume, mute, equalizer controls, skin selection controls, and so on. Such controls are common with many SW media players. Touch screen 105 of Smartphone 101 includes a navigation control set 110 that includes a control for playing music (current mode), a control for playing video, a control for playing radio (sourced online), and a control for viewing and editing settings relative to the current mode of the Smartphone.

Solid-state music player 102 is in a state of being ejected from Smartphone 101. The player is ejected in the general direction of the arrow placed underneath the player. In this case lock lever 111 is slid all the way down the track enabling unfettered ejection. Several tasks may be performed while the solid-state music player is docked in docking bay 117 on Smartphone 101. Solid-state player 102 may be charged while it is docked. When Smartphone 101 is being charged, the solid-state player is also charged at the same time. In one embodiment the solid-state player takes charge from the battery of the Smartphone if the Smartphone is not plugged in for charging. Other charging methods are available and are known to the inventor such as magnetic charge pads and vehicle adaptors.

Solid-state music player 102 has a touch screen 112 provided thereon, which may occupy part of or all of the front area of the player. Touch screen 112 may be an OLED touch screen. Touch screen 112, like touch screen 105, on Smartphone 101 includes a set of player controls 116, a graphics window 113 for displaying an album cover, or some other art or animation. Touch screen 112 includes an equalizer bar and associated controls 115. In this example a play list 114 on touch screen 112 is the same as the list 107 open Smartphone touch screen 105. Once ejected from Smartphone 101, solid-state music player 102 may function as a standalone music player where the songs played are selected from the touch screen interface on the front of the player.

In one embodiment of the present invention, Smartphone 101 may stream music for playback to solid-state music player 102 over a wireless connection once it is ejected from docking bay 117. Solid-state music player 102 includes wireless transceiver capability for receiving music streams from and sending music streams to another device for playback purposes. A wireless connection such as a Bluetooth™ connection may also be used for file synchronization and file download or upload and transfer. More detail about internal components of solid-state music player 102 is provided later in this specification.

Solid-state music player 102 may be adapted to play MP3 files, AVI files, and any other digital music or video compression formats. In one embodiment player 102 may, in addition to playing music, display images and play movies. In this case, touch screen 112 would contain navigation controls to invoke those features. Other features and links may also be provided like radio links, TV links, and so on.

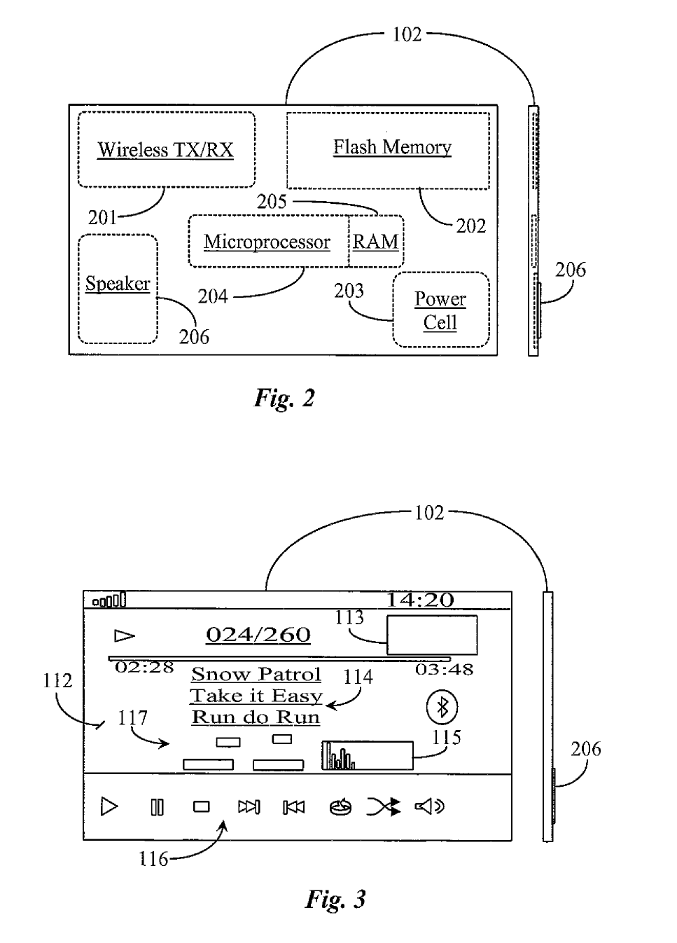

FIG. 2 is a front view of music player 102 with the touch screen display removed for clarity. Solid-state music player 102 is illustrated in front elevation and in right side view to illustrate the ultra thin profile of the device. Music player 102 includes a microprocessor 204 and a small amount of random access memory (RAM) 205 for loading boot instructions and applications installed on the device. Solid-state music player 102 is a standalone music player and includes a rechargeable battery or power cell 203 and a speaker or speaker system 207. Solid-state music player 102 contains a Flash memory 202 for storing media like music files, images, and movie files assuming the latter media is supported by the device.

Solid-state music player 102 includes a wireless transceiver (TX/RX) 201 to enable receipt of wirelessly streamed music from another wirelessly-enabled device or system for play on the device. Music may be wirelessly streamed from player 102 to another wirelessly-enabled device or system such as a stereo system, a wireless headset, or some other device having a music player and speaker system for rendering the music files. In this example, solid-state music player includes a charging contact 206 fixedly attached to the rear surface for enabling a contact charge when the player is docked into a host system or device like Smartphone 101.

FIG. 3 is a front view of solid-state music player 102 with the touch-screen display illustrated in player mode. Touch screen display 112 includes at minimum, playback control set 116, equalization bar 115, and dynamic graphics display 113. In one embodiment, the device supports processing of a radio streams and a navigation control set 117 is provided so that a user may navigate to a pre-set radio station broadcasting online and may connect to a live radio stream. Control set 117 may also include links to one or more online TV and movie providers that may aggregate several online media sources or stations that can be pre-set in a control panel so that the shortcut icons to those sources can be readily displayed on touch screen 112.

Solid-state music player 102 may be operated as a standalone music player once ejected from a host Smartphone like Smartphone 101. In this regard a user may physically hold the player while playing music. In one embodiment an accessory stand may be provided for stationing the solid-state music player for stationary playback such as from a countertop.

In one embodiment a wrist band or arm band is provided that includes a pocket with a transparent face so the user may still access touch screen options. In this embodiment a user may eject player 102 from its host system and insert the player into the pocket of wrist band or arm band. In this way the player may be operated more safely and conveniently in portable mode during higher level activities like while jogging, working out, snowboarding, and so on.

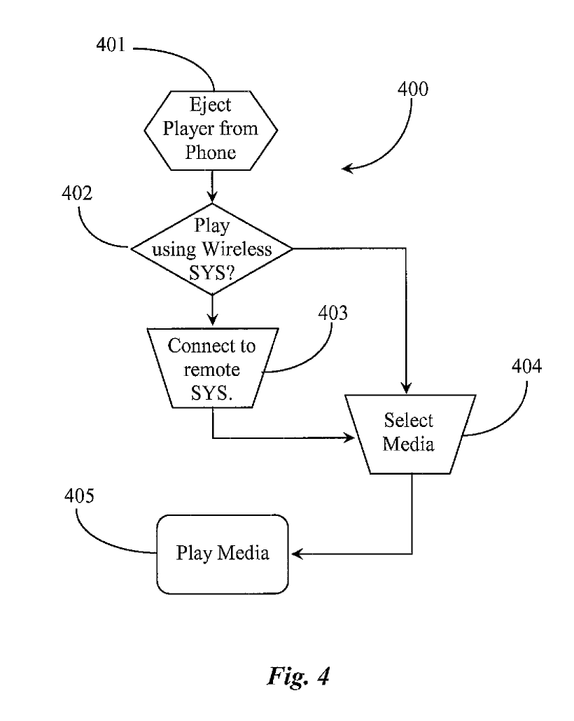

FIG. 4 is a process flow chart 400 illustrating steps for ejecting the player to listen to music. At step 401 a user ejects the solid-state music player from the host system. In this step the user may slide a lock lever down to the bottom of a track after eject is selected unlocking a spring mechanism (not illustrated) for physically ejecting the player from the host. At this point the player may be ready to play selected music.

At step 402 the user might decide whether to play music by streaming it wirelessly from the solid-state music player to a remote system. If at step 402 the user decides to stream music to another system, at step 403 the user establishes a wireless connection between the player and a remote system having speakers and a compatible music player at step 403. If at step 402 the user determines not to stream music to another system, then at step 404 the user may select media for playback using the touch screen interface on the player. After connection the player wirelessly to a remote system at step 403, the user may select media for playback at step 404. At step 405 the user plays media from the device.

It is noted herein that when the solid-state music player is docked with a Smartphone, it may be the default player of the system. In this aspect it is possible to stream music wirelessly from the docked player to another wirelessly-enabled music system. In one aspect the user makes a decision at step 402 whether the Smartphone will be used to wirelessly stream music to the un-docked solid-state music player.

It will be apparent to one with skill in the art that the music rendering system of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

What is claimed is:

1. A solid-state music player comprising:
a writable and erasable memory for storing music and a digital music player application;
a speaker system for providing audio;
a rechargeable battery for powering on the music player; and
an interactive touch screen interface for controlling the functions and features of the music player;
wherein the music player may be removably docked into a docking bay provided in a communications device and then ejected for play in standalone mode.

2. The solid-state music player of claim 1 having a form factor including a length, width, and thickness adapted for insert into a card slot provided in the communications device, the communications device functioning as a host device and docking station for the solid-state music player.

3. The solid-state music player of claim 2 wherein the communications device is a Smartphone.

4. The solid-state music player of claim 1 further including a wireless transceiver and circuitry.

5. The solid-state music player of claim 1 wherein the touch screen is an organic light emitting diode (OLED) touch screen.

6. The solid-state music player of claim 1 insertable into a pocket of a wearable arm or wrist band during standalone play.

7. A music storing and rendering system comprising:
a solid-state music player including a writable and erasable memory for storing music, a speaker system for providing audio, a rechargeable battery, and an interactive touch screen interface; and
a communications device having a card slot with a form factor including a length, width, and thickness provisioned to accept the solid-state player in a removable state of docking.

8. The system of claim 7 wherein the solid-state music player is accessible from a touch screen provided on the communications device.

9. The system of claim 8 wherein the communications device is a Smartphone.

10. The system of claim 8 wherein the touch screens are OLED touch screens.

11. The system of claim 7 wherein the card slot includes a mechanism for writing to and erasing from the memory of the solid-state music player while docked therein, the tasks controllable from one or more controls on the communications device.

12. The system of claim 7 further including a port for recharging a first rechargeable battery on the communications device and a second rechargeable battery on the solid-state music player.

13. The system of claim 7 wherein music may be streamed wirelessly from the communications device to the solid-state music player while it is not docked to the communications device.

14. The system of claim 7 wherein music may be streamed wirelessly from the solid-state music player to a hosted speaker unit or system while it is not docked to the communications device.

15. The system of claim 7 wherein the solid-state music player and the communications device may be wirelessly synchronized to enable the same music selections stored for playback from either device.

16. Using a music storing and rendering system including a solid-state music player with a writable and erasable memory for storing music, a speaker system for providing audio, a rechargeable battery, and an interactive touch screen interface, and a communications device having a card slot with a form factor including a length, width, and thickness provisioned to accept the solid-state player in a removable state of docking, a method for establishing a potable music station comprising the steps:
(a) with the solid-state music player docked into the communications device, writing at least one music file to the memory on the player from another memory storing the at least one file;
(b) ejecting the solid-state music player from the communications device;
(c) staging the solid-state music player for listening to music;
(d) selecting at least one of the stored music files; and
(e) playing the at least one music file.

17. The method of claim 16 wherein in step (a), the music player charges while docked into the communications device.

18. The method of claim 16 wherein in step (b), the solid-state music player is physically ejected by touching an icon on a touch screen on the communications device.

19. The method of claim 16 wherein in step (c), the solid-state music player is inserted into a transparent pocket of an arm band or wrist band.

20. The method of claim 16 wherein in step (d), selection is made using a touch screen provided on the solid-state music player.
